(19) United States
(12) Patent Application Publication
(10) Pub. No.: US 2016/0196695 A1
(43) Pub. Date: Jul. 7, 2016

(54) SYSTEM AND METHOD FOR MANAGING A PARKING PROCESS OF A VEHICLE IN A PARKING ZONE WHICH IS SUBJECT TO CHARGES, AND FOR MANAGING A COUNTING PROCESS FOR PAYING PARKING CHARGES

(71) Applicant: SUNHILL TECHNOLOGIES GMBH, Erlangen (DE)

(72) Inventors: Matthias MANDELKOW, Bubenreuth (DE); Christoph SCHWARZMICHEL, Hoechstadt (DE)

(21) Appl. No.: 14/908,583

(22) PCT Filed: Jul. 31, 2014
(86) PCT No.: PCT/EP2014/002104

§ 371 Date: Jan. 29, 2016

(30) Foreign Application Priority Data
Aug. 1, 2013 (EP) 13179011.5

(51) Int. Cl. G07B 15/02

(52) U.S. Cl. CPC G07B 15/02

(57) ABSTRACT

A system and method are disclosed for managing a parking process of a vehicle in a parking zone which is subject to charges. The system includes a control device; a device for generating and outputting a parking receipt and generating an identifier on the parking receipt; an entry-blocking device which, when a parking receipt is output, opens or can be opened; a device for receiving a parking receipt which detects the identifier of the parking receipt to trigger and/or carry out a counting process; an exit-blocking device which, when the identifier is detected, opens or can be opened. The control device is designed to receive the identifier via the communication network; generate an exiting permission signal, in response to the transfer of the identifier of the parking receipt; and trigger the counting process and/or carry it out as soon as the exit blocking device is activated or has been activated.

### PRIORITY STATEMENT

This application is the national phase under 35 U.S.C. §371 of PCT International Application No. PCT/EP2014/002104 which has an International filing date of Jul. 31, 2014, which designated the United States of America and which claims priority to European patent application number EP13179011.5 filed Aug. 1, 2013, the entire contents of which are hereby incorporated herein by reference.

### FIELD

A system and method are generally disclosed for managing a parking process of a vehicle in a parking zone which is subject to charges and for managing a payment process for paying parking fees or charges.

An embodiment of the present invention generally relates to a system for managing a parking process of a vehicle in a parking zone which is subject to charges and for managing a payment process for paying accrued parking fees. In addition, an embodiment of the present the invention also generally relates to a method for operating the inventive system.

### BACKGROUND

Methods and systems are known from the prior art which allow a predesignated parking in individual, localizable parking spaces in free parking zones, using different approaches. Wireless signal transmission and, in particular, mobile radio generally are used for this.

A parking system subject to charges or fees is known specifically from the WO 96/27170 A (Parkit Oy) and is provided with a control unit with parking-fee register that allows assigning the parking space to a user's vehicle and to determine the fee for the parking period on the basis of stored data for parking fees and the associated parking period information, which fee is then debited from a user account.

A parking fee system is furthermore proposed in the WO 01/88 855 A (=EP 1 312 049 B1 (Payway Oy)) for which a central unit for parking fees is activated via a parking ticket device and is connected to the user via mobile radio network. When leaving the parking zone, an exit control device is activated via the parking fee central unit with the aid of a ticket-specific exit permission code.

The WO 01/88 856 A (=EP 1312 050 B1 (Payway Oy)), on the other hand, proposes defining individual parking spaces for the parking process and the storing the parking space information additionally in the register of the central parking fee unit for determining the correct parking fee.

The unique feature of the aforementioned systems is that the payment function—corresponding to the older prior art—is realized prior to leaving the parking zone. To be sure, it is already realized therein via cell phone and mobile radio systems, but always requires a separate check-in and check-out process. During the check-out, the permission to exit is valid only for a specific time interval during which the exit gate opens up. If the time interval is exceeded, the complete check-out process must be repeated. In practice this results in an undesirable time expenditure for the user and the operator and is problematic, especially if the time interval expires just before the attempt to exit since it frequently causes an undesirable jam in the parking zone, causing high annoyance for the user.

### SUMMARY

At least one embodiment of the present invention provides an improved system and/or associated method for operating the system which simplifies the managing of the parking process and the associated process for paying the parking fees, but in an appropriate manner.

At least one embodiment of the present invention provides an improved system. A sequence of method steps is carried out in at least one embodiment to realize at least one embodiment of the system.

In at least one embodiment of the invention, technical devices are provided which communicate with a control device. On the one hand, user-specific information for specific marginal conditions of the parking process is thus transmitted in the form of identification signals to the control unit where this information is processed and is then returned via a communication network for releasing the exit. On the other hand, the parking fees are debited from the user account only after exiting the parking zone. The above-described problem situations are thus solved because the actual payment process takes place only after exiting through the gate system. The user can thus always exit and the operator is accorded the actual fee for the total parking period inside the object. The system is fully supported by mobile radio—in particular also by SMS—wherein other transmission methods such as bluetooth can also be used.

For the realization of at least one embodiment of the invention, using a gate for the parking zone, the gate is not—as with the above-described prior art—opened during the time interval in response to an exit permission code which confirms the payment of the parking fee. Rather, the parking fee is determined precisely during the exit and is debited/or paid only after exiting the parking zone. For the operator of the parking facility this ensures a better accounting option for the correct parking period, and for the consumer (user) it ensures actual independence from specified time intervals during the exit from the parking zone following the check-out.

On the whole, this results in a considerable improvement of the total system.

In detail, at least one embodiment of the invention therefore relates to a system for managing a parking process of a vehicle in a parking zone subject to charge and a payment process for paying parking fees, comprising:
a control unit for controlling the parking process and the payment process, wherein the control unit is connected to a communication network;
a device for generating and issuing a parking ticket which communicates with the control unit, wherein the device for generating and issuing a parking ticket is embodied such that it generates an identifier on the parking ticket;
an entry blocking device, which is embodied and communicates with the control unit and/or the device for generating and issuing a parking ticket, such that it opens up or can open up once a parking ticket is issued;
a device for accepting a parking ticket which communicates with the control unit, wherein the device for accepting a parking ticket is designed to detect the identifier on the parking ticket in order to release and/or realize a payment process;
an exit blocking device, embodied to communicate with the control unit and/or the device for accepting a parking ticket, such that it opens up or can open up upon detecting the identifier,
   the control unit is embodied to receive the identifier via the communication network;
   the control unit is embodied to generate an exit permission signal in response to a user transmitting the identifier on the parking ticket to the control unit; and
   the control unit is embodied such that it triggers and/or realizes the payment process as soon as the exit blocking device is activated or was activated.

At least one embodiment of the invention relates to the associated method for managing a parking process for a vehicle in a parking zone subject to charges and a payment process for paying the parking fees, with a control unit for controlling the parking process and the payment process, wherein the control unit is connected to a communication network, wherein the method comprises the following steps:
generating and issuing a parking ticket upon request from a user with the aid of a device that communicates with the control unit for generating and issuing a parking ticket;
wherein the device for generating and issuing a parking ticket generates an identifier on the parking ticket;
opening of an entry blocking device which is embodied in such a way and communicates with the control unit and/or the device for generating and issuing a parking ticket that the blocking device opens up or can be opened once the parking ticket is issued;
accepting of the parking ticket in a device for accepting a parking ticket which communicates with the control unit and detecting of the parking ticket via the device for accepting a parking ticket in order to release and/or realize a payment process;
opening of an exit blocking device which is embodied such and is communicates with the control unit and/or the device for accepting a parking ticket, so that the blocking device is opened or can be opened once the identifier is detected, wherein the control unit receives the identification via the communication network
wherein the control unit generates an exit permission signal in response to the transmission from the user of the identifier on the parking ticket to the control unit;
wherein the control unit triggers and/or realizes the payment process as soon as the exit blocking device is or was activated.

### BRIEF DESCRIPTION OF THE DRAWINGS

Additional details and advantages of the invention follow from the description below of exemplary embodiments in connection with the individual patent claims, which show in:

FIG. 1 a configuration for the system, using concrete tickets and entry and/or exit blocking devices and

FIG. 2 a chronological flow chart showing the time period from the start to the end of the parking process, including the payment.

The same or similar units in the Figures are given the same reference numbers.

In the Figures, the reference 10 relates to a control unit and 20 to a communication network which interact with each other. The control unit 10 is connected via the communication network 20 to additional units.

### DETAILED DESCRIPTION OF THE EXAMPLE EMBODIMENTS

In detail, at least one embodiment of the invention therefore relates to a system for managing a parking process of a vehicle in a parking zone subject to charge and a payment process for paying parking fees, comprising:
a control unit for controlling the parking process and the payment process, wherein the control unit is connected to a communication network;
a device for generating and issuing a parking ticket which communicates with the control unit, wherein the device for generating and issuing a parking ticket is embodied such that it generates an identifier on the parking ticket;
an entry blocking device, which is embodied and communicates with the control unit and/or the device for generating and issuing a parking ticket, such that it opens up or can open up once a parking ticket is issued;
a device for accepting a parking ticket which communicates with the control unit, wherein the device for accepting a parking ticket is designed to detect the identifier on the parking ticket in order to release and/or realize a payment process;
an exit blocking device, embodied to communicate with the control unit and/or the device for accepting a parking ticket, such that it opens up or can open up upon detecting the identifier,
   the control unit is embodied to receive the identifier via the communication network;
   the control unit is embodied to generate an exit permission signal in response to a user transmitting the identifier on the parking ticket to the control unit; and
   the control unit is embodied such that it triggers and/or realizes the payment process as soon as the exit blocking device is activated or was activated.

The system and the corresponding method of at least one embodiment are used in gated parking zones or parking garages which can be accessed by vehicles, meaning motor vehicles, via entrance and/or exit gates and in which vehicles can be parked for a specific period of time in return for a fee. The user approaches the parking zone, requests a parking ticket at the entrance and, following the opening of the entrance blocking device, in particular a gate, can then drive into the parking zone or the parking garage. The parking ticket now contains a specific identification or ticket ID as well as an address which can be used later for the payment process. The address can be a speed dial number which can be contacted, e.g. via short-message-service (SMS), or which can be triggered by scanning in a QR (quick response) or a barcode.

A user wanting to pay via the system, for example, sends a SMS with the ticket ID, meaning the identifier affixed to the parking ticket, to a specified speed dial number. The user then receives a confirmation via SMS. As soon as the user receives this confirmation he/she can leave the gated parking zone or space with the vehicle at any time by inserting the ticket, as usual, into the device provided for it. The transmitted ticket ID or identifier only serves to detect the ticket. It does not contain information relating to the entry/exit point in time for the vehicle, on rates, or the length of the parking period. The amount for the parking fee is based on the respectively valid local parking fee structure for the parking garage operator. The amount owed upon exit is automatically debited following the exit. The fees are debited, for example, via mobile radio and/or from a prepaid account or the user's client account.

When leaving the parking zone, meaning the parking garage, the parking period and the amount due are computed by the parking garage operator. The system for managing a parking process of a vehicle in a fee-based parking zone and a payment process for paying the parking fees debits this amount from the respective account of the user and informs the user via SMS.

If, owing to a temporary non-availability of the services, the payment of the parking fee via cell phone is not possible or if an exit signal cannot be generated, e.g. because the account has insufficient funds, the parking space user is still owes the fee. In that case, alternative payment options are to be used, for example a cash register.

For the specific embodiment of at least one embodiment of the invention, the control unit is embodied such that the identifier can be transmitted via short-message-service (SMS) from a mobile radio device of the user. Alternatively, the identifier can also be transmitted via on-board unit (e.g. navigation system), via barcode or near-field communication (NFC) or a similar near-field frequency communication, or via an APP, for example a smart phone APP.

According to one embodiment of the invention, the control unit is embodied such that the parking fee can be determined following the transmission of the identifier, preferably via SMS.

According to a different embodiment of the invention, the control unit is embodied such that it can monitor whether a user-specific account has sufficient funds for paying the parking fee, so that an exit permission is generated only if there are sufficient funds.

The control unit according to another embodiment of the invention is embodied such that the exit permission is generated only if it can be confirmed that the parking fee can be debited or collected. That is to say, specific conditions must be met which make it possible to generate the exit permission and finally the opening of the exit blocking device. A user-specific account can be a bank account or an account for prepayment (account in credit), a credit card, a mobile wallet or a similar account.

According to one embodiment of the invention, the control unit is embodied such that the user receives a confirmation, preferably a SMS, indicating the possibility of exiting. With this information, the user is informed that payment is possible (e.g. that the account has sufficient funds) and that exiting is possible, meaning an opening of the exit blocking device, e.g. a gate in a parking garage, as soon as the ticket is inserted in the receptacle for the parking ticket. The confirmation can read as follows: your identification was accepted by the system.

For the embodiments according to the invention, the entrance blocking device is embodied as a gating device or gate. According to one embodiment, the exit blocking device is embodied as exit gating device or gate. The blocking devices are advantageously also used to detect the parking event and for securing the payment, wherein this can also be achieved with virtual gating devices, e.g. a combination of identifier detection and on-board unit and/or APP, for example a smartphone APP.

According to one embodiment of the invention, the control unit is designed at least in part as a separate device. As a separate device it can also form a component of the vehicle.

According to one embodiment of the invention, the control unit is designed to form a component of the device for generating and issuing a parking ticket and/or the device for accepting a parking ticket and/or the entrance blocking device and/or the exit blocking device.

The control unit of another embodiment comprises a storage device for storing data, preferably rate information and/or information on the parking duration.

According to one embodiment of the invention the control unit and/or the device for generating and issuing a parking ticket and/or the entrance blocking device is/are designed so as to detect/record a moment for generating the parking ticket and/or moment of entering, so that this/these moment(s) can be stored in the control unit.

For the embodiments of the invention, the entering moment is the point in time when the entrance blocking device opens up.

According to one embodiment of the invention, the control unit and/or the device for generating and issuing a parking ticket and/or the exit blocking device is/are designed to detect/record an exit moment on the parking ticket, so that this moment/these moments can be stored in the storage device of the control unit. The information required for computing the parking fee (actual rate, moment of entering, moment of exit etc.) can thus be stored in the control unit, especially in one or in the storage device, so that following the transmission of the identifier on the parking ticket, the fee that is due can be computed. The identifier itself does not contain any information to that effect.

According to one embodiment of the invention, the control unit and/or the system is/are designed such that the parking fee can be debited via the user-specific account or from this account.

At least one embodiment of the invention relates to the associated method for managing a parking process for a vehicle in a parking zone subject to charges and a payment process for paying the parking fees, with a control unit for controlling the parking process and the payment process, wherein the control unit is connected to a communication network, wherein the method comprises the following steps:
generating and issuing a parking ticket upon request from a user with the aid of a device that communicates with the control unit for generating and issuing a parking ticket;
wherein the device for generating and issuing a parking ticket generates an identifier on the parking ticket;
opening of an entry blocking device which is embodied in such a way and communicates with the control unit and/or the device for generating and issuing a parking ticket that the blocking device opens up or can be opened once the parking ticket is issued;
accepting of the parking ticket in a device for accepting a parking ticket which communicates with the control unit and detecting of the parking ticket via the device for accepting a parking ticket in order to release and/or realize a payment process;
opening of an exit blocking device which is embodied such and is communicates with the control unit and/or the device for accepting a parking ticket, so that the blocking device is opened or can be opened once the identifier is detected, wherein the control unit receives the identification via the communication network
wherein the control unit generates an exit permission signal in response to the transmission from the user of the identifier on the parking ticket to the control unit;
wherein the control unit triggers and/or realizes the payment process as soon as the exit blocking device is or was activated.

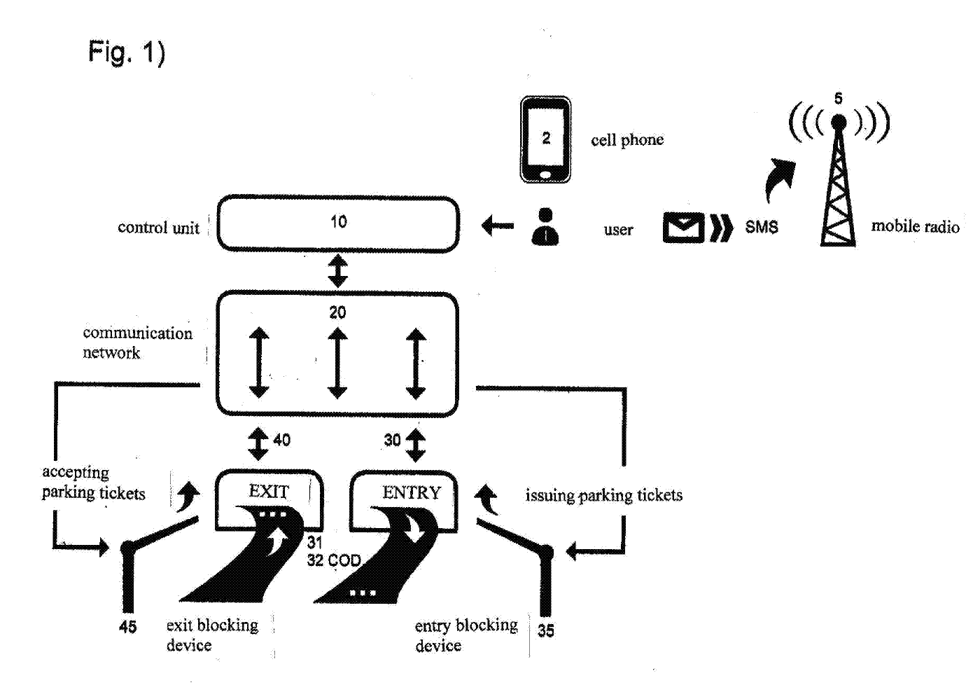

In FIG. 1 specifically, the control device 10 is connected to a user 1 with cell phone 2 and the associated mobile radio network 5 and a central unit. A ticket issuing device 30 is provided which issues a ticket 31 with specific identifier 32. The identifier 32 serves to identify the user/vehicle and can be realized in the form of a barcode.

The ticket issuing device 30, in turn, is connected to the entry blocking device 35. Parallel thereto, a ticket intake device 40 with exit blocking device 45 is provided.

When entering the gated parking zone, the ticket 31 is issued in the usual manner following a request. The identifier (code) is generated in the process on the ticket. Via the identifier 31, the user-specific data of the user 1 are transmitted via the communication network 20 to the control unit 10 for the individual identification. The entry blocking device 35 is then opened.

At the end of the parking period, the ticket 31 with identifier 32 is inserted into the ticket intake device 40. The ticket intake device 40, in turn, is connected to the exit blocking device. Once the ticket 31 with identifier 32 is inserted into the ticket intake device, the information including the time signal is transmitted via the communication network 20 to the control unit 10. The payment can be processed in the control unit 10 with the aid of the signal, and an exit permission signal is generated therein for the exit blocking device 45, embodied as a gate. The determined parking fee is transmitted by the control unit 10 via SMS or the like to the user 1.

In FIG. 1, the control device 10 with the following communication network 20 and further units are part of the central control for the parking zone, which establishes the connection via the mobile network to the external computer.

The control unit 10 can also be embodied as a separate component and can be installed in the user's vehicle. The exchange of information takes place in the same way from there, using the communication network 20 with near-field method whenever the vehicle approaches the parking zone.

A parallel application describes the option of using the invention in non-gated parking zones, meaning in parking zones without barriers. In place of the concrete demarcation of the parking zones and monitoring via a ticket, only the exchange of identification signals is important in that case. The blocking of the entrance and the exit in that case are realized virtually.

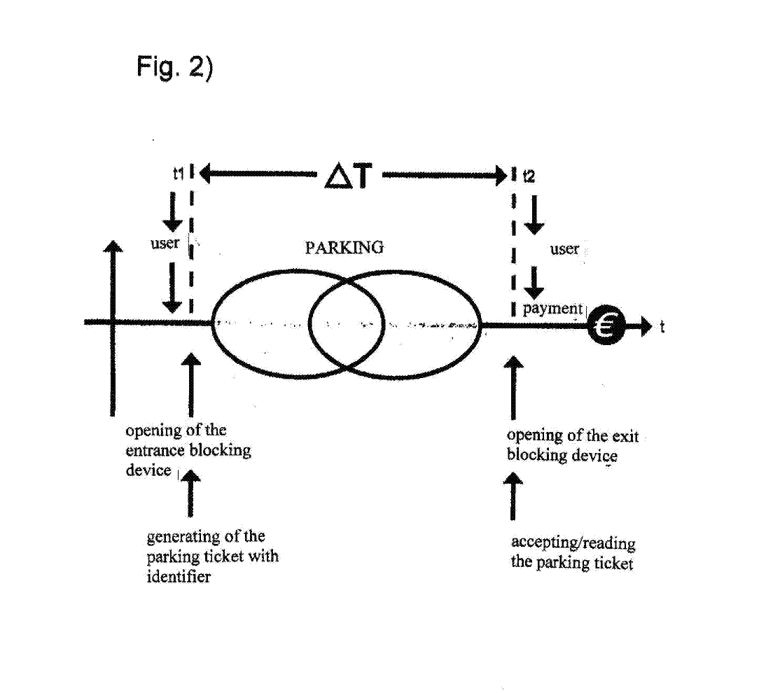

FIG. 2 clearly shows the chronological sequence of steps of the system for managing the parking process and the payment process. Individual action moments are plotted over time: t1 relates to the moment of entry, Delta T relates to the parking period and t2 relates to the moment of exit. Essential is that the billing occurs after the exit.

### REFERENCE NUMBER LIST

1 user
2 cell phone
3
4
5 mobile radio station
10 control unit
20 communication network
30 ticket issuing device
31 ticket
32 identifier
35 entry blocking device (gate)
40 ticket intake device
45 exit blocking device (gate)
t time axis
t1 start of parking period
t2 end of parking period
Delta T parking period

1. A system for managing a parking process for a vehicle in a parking zone subject to charges and a payment process for the parking fees, comprising:
a control unit embodied to control the parking process and the payment process, wherein the control unit is connected to a communication network for transmitting signals;
a device embodied to generate and issue a parking ticket to communicate with the control unit, wherein the device to generate and issue a parking ticket is further embodied to generate an identifier on the parking ticket;
an entry blocking device embodied to communicate with at least one of—the control unit and the device to generate and issue a parking ticket, and embodied to open be opened upon issuance of a parking ticket;
a device embodied to communicate with the control unit and to serve to accept a parking ticket, wherein the device to accept a parking ticket is designed to detect the identifier on the parking ticket to at least one of trigger and realize a payment process; and
an exit blocking device embodied to communicate with at least one of—the control unit and the device to accept a parking ticket and embodied to open up or be opened upon detecting the identifier,
wherein
the control unit is embodied to receive the identifier via the communication network;
the control unit is embodied to generate an exit permission signal in response to transmitting to a user transmitting the identifier on the parking ticket to the control unit; and
the control unit is embodied to at least one of—trigger and realize the payment process as soon as the exit blocking device is or was activated.

2. The system of claim 1, wherein the control unit is embodied such that the identifier is transmittable from a mobile radio device of the user via short-message service (SMS).

3. The system of claim 1, wherein the control unit is embodied such that following the transmission of the identifier, the parking fee is determinable.

4. The system of claim 1, wherein the control unit is embodied such that the user-specific account is monitorable to ensure containment of sufficient funds for the parking fee, and is embodied to generate the exit permission signal only if sufficient funds exist.

5. The system of claim 1, wherein the control unit is embodied to generate the exit permission only if it is confirmed that the parking fee can be debited or collected.

6. The system of claim 1, wherein the control unit is embodied to send the user a confirmation to indicate permission to exit.

7. The system of claim 1, wherein the entry blocking device is embodied as entry gating device.

8. The system of claim 1, wherein the exit blocking device is embodied as exit gating device.

9. The system of claim 1, wherein the control unit is embodied at least in part as a separate device.

10. The system of claim 1, wherein the control unit is embodied as a component of at least one of the device to generate and issue a parking ticket, the device to accept a parking ticket, the entry blocking device and the exit blocking device.

11. The system of claim 1, wherein the control unit comprises a storage device for storing data, preferably rate information and/or parking duration information.

12. The system of claim 1, wherein at least one of—the control unit, the device to generate and issue a parking ticket, and the entry blocking device is embodied to detect at least one of a moment for generating the parking ticket and a moment of entry, to store the at least one moment in the control unit.

13. The system of claim 12, wherein the entry moment is the moment when the entry blocking device opens up.

14. The system of claim 1, wherein at least one of—the control unit, the device to accept a parking ticket and the exit blocking device is embodied to detect an exit moment for the parking ticket, to store the at least one moment in the control device of the control unit.

15. The system of claim 1, wherein at least one of the control unit and the system is embodied to allow debiting the parking fee from the user-specific account.

16. A method for managing a parking process for a vehicle in a parking zone subject to charges, and a payment process for paying parking fees, including a control unit to control the parking process and the payment process, the control unit being linked to a communication network,
the method comprising:
generating and issuing a parking ticket upon request by a user, with aid of a device for generating and issuing a parking ticket which communicates with the control unit, wherein the device for generating and issuing a parking ticket generates an identifier on the parking ticket;
opening an entry blocking device, embodied to communicate with at least one of the control unit and the device for generating and issuing a parking ticket and embodied to open or be opened when a parking ticket is issued;
accepting and reading the parking ticket into a device for accepting the parking ticket which communicates with the control unit and detecting the identifier on the parking ticket via a device for accepting a parking ticket in order to at least one of trigger and realize a payment process; and
opening an exit blocking device, designed to communicate with at least one of the control unit and the device for accepting a parking ticket and designed to open or be opened—upon detecting the identifier,
wherein
the control unit receives the identifier via the communication network;
the control unit generates an exit permission signal in response to a user transmitting the identifier on the parking ticket to the control unit, and
the control unit at least one of triggers and realizes the payment process, as soon as the exit blocking device is or was activated.

17. The method of claim 16, wherein at least one of the signals and data are transmitted via SMS and supported by mobile radio or bluetooth.

18. The system of claim 2, wherein the control unit is embodied such that following the transmission of the identifier via SMS, the parking fee is determinable.

19. The system of claim 2, wherein the control unit is embodied to send the user a confirmation, via SMS, to indicate permission to exit.

20. The system of claim 11, wherein the data includes at least one of rate information and parking duration information.
